(19) United States
(12) Patent Application Publication
(10) Pub. No.: US 2015/0370379 A1
(43) Pub. Date: Dec. 24, 2015

(54) TOUCH PANEL AND RESIN COMPOSITION FOR FORMING PROTECTIVE LAYER

(71) Applicant: FUJIFILM CORPORATION, Tokyo (JP)

(72) Inventors: Toshiaki HAYASHI, Kanagawa (JP); Yuki MATSUNAMI, Kanagawa (JP); Yasuhiro MITAMURA, Kanagawa (JP)

(73) Assignee: FUJIFILM CORPORATION, Tokyo (JP)

(21) Appl. No.: 14/840,167

(22) Filed: Aug. 31, 2015

Related U.S. Application Data
(63) Continuation of application No. PCT/JP2014/057326, filed on Mar. 18, 2014.

(30) Foreign Application Priority Data
Mar. 18, 2013 (JP) 2013-054854

(51) Int. Cl. G06F 3/044; G06F 3/047

(52) U.S. Cl. CPC G06F 3/044; G06F 3/047; G06F 2203/04103; G06F 2203/04104

(57) ABSTRACT

A touch panel having an input region and an outside region positioned outside the input region includes at least: a substrate; detection electrodes disposed on the substrate corresponding to the input region; lead-out wirings which are disposed on the substrate corresponding to the outside region and are electrically connected to the detection electrodes; and a protective layer disposed on the substrate corresponding to the outside region so as to cover the lead-out wirings. The protective layer is formed by using an epoxy resin, and the lead-out wirings contain metal silver and gelatin. In the touch panel, the occurrence of ion migration between lead-out wirings is further inhibited.

### CROSS-REFERENCE TO RELATED APPLICATIONS

This application is a Continuation of PCT International Application No. PCT/JP2014/057326 filed on Mar. 18, 2014, which claims priority under 35 U.S.C. §119(a) to Japanese Patent Application No. 2013-054854 filed on Mar. 18, 2013. The above application is hereby expressly incorporated by reference, in its entirety, into the present application.

### BACKGROUND OF THE INVENTION

The present invention relates to a touch panel, and particularly, to a touch panel having a protective layer disposed on lead-out wiring containing metal silver and gelatin.

Furthermore, the present invention relates to a resin composition for forming a protective layer used for forming a protective layer that covers lead-out wiring.

In recent years, a touch panel has been more frequently mounted on cellular phones, mobile game consoles, and the like, and for example, a capacitance-type touch panel that can perform multipoint detection has drawn attention.

The basic structure of the touch panel is composed of a substrate, detection electrodes for detecting an input position that are provided on the substrate, and lead-out wirings for applying voltage to the detection electrodes. As the method for manufacturing the detection electrodes or the lead-out wirings, a method for forming thin conductive wires with low resistance from a silver image which is obtained by developing a silver halide photographic sensitive material is under examination (JP 2012-004042 A).

### SUMMARY OF THE INVENTION

The silver-containing thin conductive wires manufactured from the silver halide photographic sensitive material have a problem in that ion migration easily occurs. When the ion migration occurs between the thin conductive wires, the thin conductive wires become conductive to each other, and thus the wires cannot function as a circuit.

Particularly, in recent years, as the products have been required to be further miniaturized and to demonstrate higher performance, the wiring interval has been further narrowed, and therefore the conduction of a circuit has more easily occurred due to ion migration. For example, in the field of touch panels, a busbar and lead-out wirings are desired to be formed such that they are positioned within a very narrow frame range at the edge of a panel. Consequentially, in this situation, the space between wirings in a peripheral wiring portion is reduced, and thus conduction easily occurs due to ion migration.

The inventors of the present invention formed lead-out wirings by using the silver halide photographic sensitive material, which is described in JP 2012-004042 A and contains gelatin and silver halide, and conducted examination regarding ion migration resistance between the lead-out wirings. As a result, it was found that when the wiring interval is narrowed as described above, the ion migration resistance does not reach the currently required level and needs to be further improved.

The present invention has been made under the aforementioned current circumstances, and an object thereof is to provide a touch panel in which the occurrence of ion migration between lead-out wirings is further inhibited.

As a result of conducting intensive examination regarding the above object, the inventors of the present invention found that by disposing a protective layer formed of an epoxy resin such that it covers lead-out wirings, intended effects are obtained.

That is, the inventors found that the above object can be achieved by the following constitution.

(1) A touch panel having an input region and an outside region positioned outside the input region, comprising at least: a substrate; detection electrodes disposed on the substrate corresponding to the input region; lead-out wirings which are disposed on the substrate corresponding to the outside region and are electrically connected to the detection electrodes; and a protective layer disposed on the substrate corresponding to the outside region so as to cover the lead-out wirings, wherein the protective layer is formed by using an epoxy resin, and the lead-out wirings contain metal silver and gelatin.
(2) The touch panel according to (1), wherein the protective layer contains a filler.

According to the present invention, it is possible to provide a touch panel in which the occurrence of ion migration between lead-out wirings is further inhibited.

### BRIEF DESCRIPTION OF THE DRAWINGS

FIG. 1 is a plan view of a first embodiment of a touch panel of the present invention.

FIG. 2 is a cross-sectional view taken along cutting line A-A shown in FIG. 1.

FIG. 3 is a cross-sectional view taken along cutting line B-B shown in FIG. 1.

FIG. 4 is an enlarged plan view of a first detection electrode.

FIG. 5 is a cross-sectional view of a portion of a second embodiment of the touch panel of the present invention.

FIG. 6 is a cross-sectional view of a portion of a third embodiment of the touch panel of the present invention.

FIG. 7 is a cross-sectional view of an embodiment of an input device including the touch panel of the present invention.

FIG. 8 is a cross-sectional view of another embodiment of the input device including the touch panel of the present invention.

FIG. 9 is a cross-sectional view of another embodiment of the input device including the touch panel of the present invention.

### DETAILED DESCRIPTION OF THE INVENTION

Hereinafter, preferred embodiments of the touch panel of the present invention will be described with reference to drawings.

A characteristic of the touch panel of the present invention is that a protective film formed by using an epoxy resin is disposed to cover lead-out wirings containing metal silver and gelatin. The reason why the effects of the present invention are obtained is assumed to be as follows, although the detail thereof is unclear. Presumably, by using an epoxy resin as a material of the protective layer, the interaction between the epoxy resin and gelatin is strengthened, and the adhesion between the lead-out wiring and the protective layer is improved. It is considered that, as a result, moisture or the like does not easily exist in the interface between the lead-out wiring and the protective layer, and therefore the elution of silver ions is further inhibited.

### First Embodiment

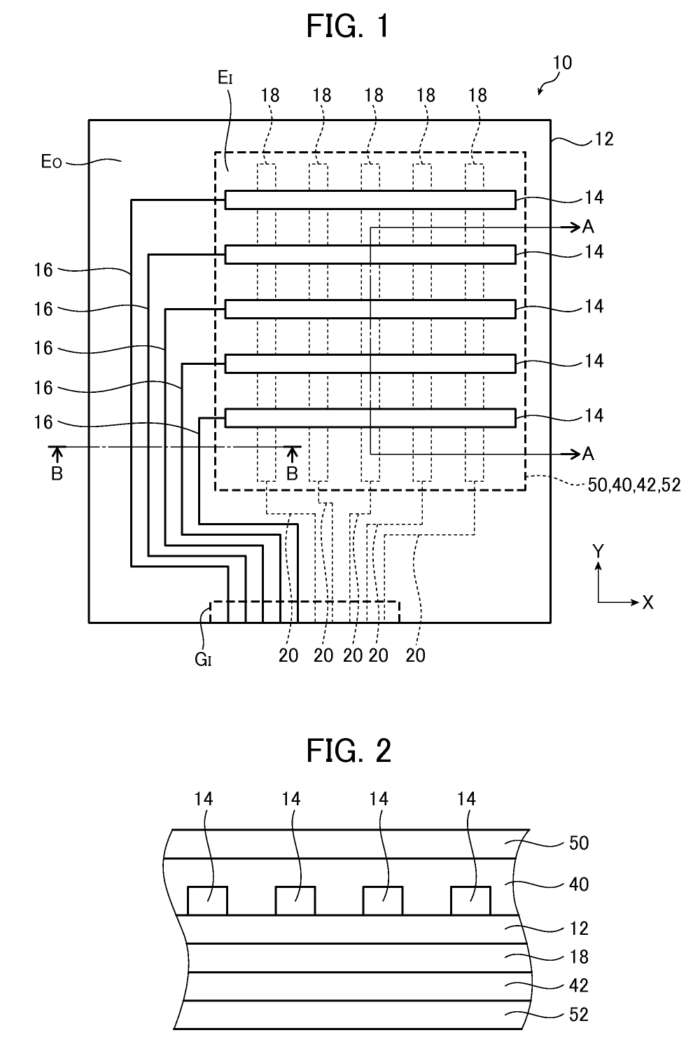

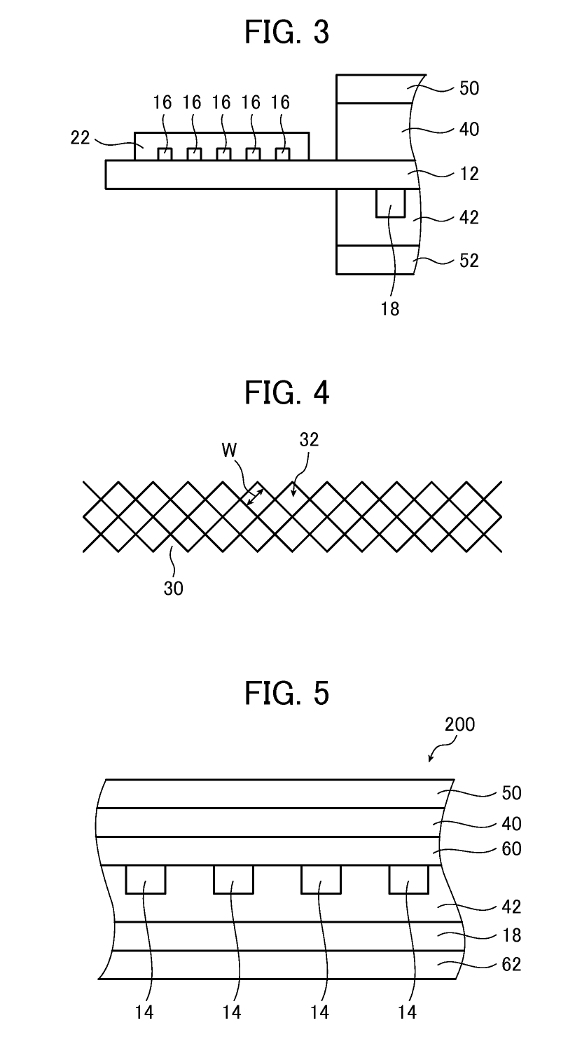

FIG. 1 is a plan view of a first embodiment of a touch panel 10 of the present invention. FIG. 2 is a cross-sectional view taken along cutting line A-A. FIG. 3 is a cross-sectional view taken along cutting line B-B. Herein, FIGS. 1 to 3 are schematic views for facilitating understanding of the layer constitution of the touch panel, and are not views accurately showing the disposition of each layer.

As shown in FIG. 1, the touch panel according to the present embodiment is a capacitance-type touch panel and has an input region E_{I} in which an input operation can be performed by a user and an outside region E_{O} which is positioned outside the input region E_{I}.

As shown in FIGS. 1 and 2, the touch panel 10 includes a substrate 12, first detection electrodes 14 disposed on one main surface (front surface) of the substrate 12, first lead-out wirings 16, a first transparent resin layer 40, a first protective substrate 50, second detection electrodes 18 disposed on the other main surface (rear surface) of the substrate 12, second lead-out wirings 20, a second transparent resin layer 42, a second protective substrate 52, and a protective layer 22. As shown in FIG. 3 which will be described later, the protective layer 22 is disposed on the substrate 12 so as to cover the first lead-out wirings 16 and the second lead-out wirings 20.

Hereinafter, the aforementioned constitution will be specifically described.

The substrate 12 is a member that plays a role of supporting the first detection electrodes 14 and the second detection electrodes 18, which will be described later, in the input region E_{I} and plays a role of supporting the first lead-out wirings 16 and the second lead-out wirings 20, which will be described later, in the outside region E_{O}.

It is preferable that the substrate 12 appropriately transmits light. Specifically, the total light transmittance of the substrate 12 is preferably 85% to 100%.

It is preferable that the substrate 12 has insulating properties. That is, the substrate 12 is a layer for securing insulating properties between the first detection electrodes 14 and the second detection electrodes 18.

The substrate 12 is preferably a transparent substrate. Specific examples of the substrate 12 include an insulating resin substrate, a ceramic substrate, a glass substrate, and the like. Among these, an insulating resin substrate is preferable since it is excellent in toughness.

More specifically, examples of the material constituting the insulating resin substrate include polyethylene terephthalate, polyether sulfone, a polyacrylic resin, a polyurethane-based resin, polyester, polycarbonate, polysulfone, polyamide, polyarylate, polyolefin, a cellulose-based resin, polyvinyl chloride, a cycloolefin-based resin, and the like. Among these, polyethylene terephthalate, a cycloolefin-based resin, polycarbonate, and a triacetyl cellulose resin are preferable since these are excellent in transparency.

Although the substrate 12 in FIGS. 1 to 3 is a single layer, the substrate 12 may be a multilayer composed of two or more layers.

The thickness of the substrate 12 (when the substrate 12 is a multilayer composed of two or more layers, which is the total thickness thereof) is not particularly limited. However, the thickness is preferably 5 μm to 350 μm, and more preferably 30 μm to 150 μm. If the thickness is within the above range, the intended visible light transmittance is obtained, and it is easy to handle the substrate 12.

The substrate 12 shown in FIG. 1 has substantially a rectangular shape when seen in a plan view. However, the shape of the substrate 12 is not limited thereto and may be circular or polygonal, for example.

In the touch panel 10, the first detection electrodes 14 and the second detection electrodes 18 are sensing electrodes sensing the change in capacitance and constitute a sensor portion. That is, when a finger tip comes into contact with the touch panel, the mutual capacitance between the first detection electrodes 14 and the second detection electrodes 18 changes, and based on the amount of change, the position of the fingertip is calculated by an IC circuit.

The first detection electrodes 14 play a role of detecting an input position of a user's finger, which approaches the input region E_{I}, in the X-direction, and have a function of generating capacitance between the first detection electrodes 14 and the finger. The first detection electrodes 14 are electrodes that extend in a first direction (X-direction) and are arranged in a second direction (Y-direction) orthogonal to the first direction at a predetermined interval. The first detection electrodes 14 have a predetermined pattern as described later.

The second detection electrodes 18 play a role of detecting an input position of a user's finger, which approaches the input region E_{I}, in the Y-direction, and have a function of generating capacitance between the second detection electrodes 18 and the finger. The second detection electrodes 18 are electrodes that extend in the second direction (Y-direction) and are arranged in the first direction (X-direction) at a predetermined interval. The second detection electrodes 18 have a predetermined pattern as described later. In FIG. 1, the touch panel 10 has five first detection electrodes 14 and five second detection electrodes 18. However, the number of the electrodes is not particularly limited and just needs to be a plural number.

In FIG. 1, the first detection electrodes 14 and the second detection electrodes 18 are constituted with thin conductive wires. FIG. 4 is an enlarged plan view showing a portion of the first detection electrode 14. As shown in FIG. 4, the first detection electrode 14 is constituted with thin conductive wires 30 and includes a plurality of lattices 32 formed by the thin conductive wires 30 crossing each other. Just like the first detection electrode 14, the second detection electrode 18 also includes the plurality of lattices 32 formed by the thin conductive wires 30 crossing each other.

Examples of the material of the thin conductive wires 30 include a metal such as gold (Au), silver (Ag), copper (Cu), or aluminum (Al), an alloy, a metal oxide such as ITO, tin oxide, zinc oxide, cadmium oxide, gallium oxide, or titanium oxide, and the like. Among these, silver is preferable since conductivity of the thin conductive wires 30 becomes excellent.

From the viewpoint of the adhesiveness between the thin conductive wires 30 and the substrate 12, the thin conductive wires 30 preferably contain a binder.

The binder is preferably a water-soluble polymer since the adhesiveness between the thin conductive wires 30 and the substrate 12 is further improved. Examples of the types of the binder include gelatin, carrageenan, polyvinyl alcohol (PVA), polyvinylpyrrolidone (PVP), polysaccharides such as starch, cellulose and derivatives thereof, polyethylene oxide, polyvinyl amine, chitosan, polylysine, polyacrylic acid, polyalginic acid, polyhyaluronic acid, carboxycellulose, gum Arabic, sodium alginate, and the like. Among these, gelatin is preferable since the adhesiveness between the thin conductive wires 30 and the substrate 12 is further improved.

Herein, as gelatin, in addition to lime-treated gelatin, acid-treated gelatin may be used. Moreover, it is possible to use a hydrolysate of gelatin, an enzymatic decomposition product of gelatin, and gelatin modified with an amino group or a carboxyl group (phthalated gelatin or acetylated gelatin).

The volume ratio of the metal to the binder (volume of metal/volume of binder) in the thin conductive wires 30 is preferably equal to or greater than 1.0, and more preferably equal to or greater than 1.5. If the volume ratio of the metal to the binder is equal to or greater than 1.0, the conductivity of the thin conductive wires 30 can be further improved. The upper limit of the volume ratio is not particularly limited. However, from the viewpoint of productivity, the upper limit is preferably equal to or less than 4.0, and more preferably equal to or less than 2.5.

The volume ratio of the metal to the binder can be calculated from the density of the metal and the binder contained in the thin conductive wires 30. For example, when the metal is silver, and the binder is gelatin, the volume ratio can be calculated under the conditions of the density of silver at 10.5 g/cm³ and the density of gelatin at 1.34 g/cm³.

The line width of the thin conductive wires 30 is not particularly limited. However, because electrodes having low resistance can be relatively easily formed, the upper limit of the line width is preferably equal to or less than 30 μm, more preferably equal to or less than 15 μm, even more preferably equal to or less than 10 μm, particularly preferably equal to or less than 9 μm, and most preferably equal to or less than 7 μm, and the lower limit thereof is preferably equal to or greater than 0.5 μm, and more preferably equal to or greater than 1.0 μm.

The thickness of the thin conductive wires 30 is not particularly limited. However, from the viewpoint of conductivity and visibility, the thickness can be selected within a range of 0.00001 mm to 0.2 mm. The thickness is preferably equal to or less than 30 μm, more preferably equal to or less than 20 μm, even more preferably 0.01 μm to 9 μm, and most preferably 0.05 μm to 5 μm.

Each of the lattices 32 includes an opening region surrounded by the thin conductive wires 30. A length W of one side of each of the lattices 32 is preferably equal to or less than 800 μm, and more preferably equal to or less than 600 μm. The length W is preferably equal to or greater than 50 μm.

In view of visible light transmittance, the opening ratio in the first detection electrodes 14 and the second detection electrodes 18 is preferably equal to or greater than 85%, more preferably equal to or greater than 90%, and most preferably equal to or greater than 95%. The opening ratio corresponds to a proportion of a transmitting portion, excluding the thin conductive wires 30 in the first detection electrodes 14 or the second detection electrodes 18 within a predetermined region, in the entire region.

The lattices 32 have the shape of approximately a rhombus. However, the lattices 32 may also have the shape of a polygon (for example, a triangle, a quadrangle, a hexagon, or a random polygon). Moreover, one side of each of the lattices may be in the form of a curved line or an arc in addition to the form of a straight line. When one side of each of the lattices is in the form of an arc, for example, two sides facing each other may be in the form of arcs curving toward the outside, and the other two sides facing each other may be in the form of arcs curving toward the inside. Furthermore, each side of the lattices may be in the form of a wavy line in which an arc curving toward the outside and an arc curving toward the inside continue. Needless to say, each side of the lattices may form a sine curve.

In FIG. 4, the thin conductive wires 30 are formed as mesh patterns. However, the thin conductive wires 30 are not limited to such an embodiment, and may be stripe patterns.

In FIG. 1, the first detection electrodes 14 and the second detection electrodes 18 are constituted with the mesh structure of the thin conductive wires 30, but the present invention is not limited to this embodiment. For example, the first and second detection electrodes 14 and 18 may be constituted with a thin film or particles of a metal oxide such as ITO or ZnO, metal paste such as silver paste or copper paste, or particles of metal nanowires such as silver nanowires or copper nanowires. Among these, in view of excellent conductivity and transparency, silver nanowires are preferable.

The patterning method of the electrode portion can be selected according to the material of the electrode portion, and a photolithography method, a resist mask screen printing-etching method, an ink jet method, a printing method, or the like may be used.

The first lead-out wirings 16 and the second lead-out wirings 20 are members that play a role of applying voltage to the first detection electrodes 14 and the second detection electrodes 18, respectively.

The first lead-out wirings 16 are disposed on the substrate 12 in the outside region E_{O}. One end of the first lead-out wiring 16 is electrically connected to a corresponding first detection electrode 14, and the other end thereof is positioned at an external conduction region G in which a flexible printed wiring board or the like is disposed.

The second lead-out wirings 20 are disposed on the substrate 12 in the outside region E_{O}. One end of the second lead-out wiring 20 is electrically connected to a corresponding second detection electrode 18, and the other end thereof is positioned at the external conduction region G in which a flexible printed wiring board or the like is disposed.

In FIG. 1, five first lead-out wirings 16 and five second lead-out wirings 20 are illustrated. However, the number of the wirings is not particularly limited, and generally, a plurality of wirings is disposed according to the number of the detection electrodes.

Metal silver and gelatin are contained in the first lead-out wirings 16 and the second lead-out wirings 20.

The type of the gelatin is not particularly limited. For example, in addition to lime-treated gelatin, acid-treated gelatin may be used. Moreover, it is possible to use a hydrolysate of gelatin, an enzymatic decomposition product of gelatin, and gelatin modified with an amino group or a carboxyl group (phthalated gelatin or acetylated gelatin).

The first lead-out wirings 16 and the second lead-out wirings 20 may contain a component other than the metal silver and gelatin.

For example, the first lead-out wirings 16 and the second lead-out wirings 20 may contain a polymer different from gelatin. When the first lead-out wirings 16 and the second lead-out wirings 20 contain the polymer different from gelatin, a mass ratio of the polymer different from gelatin to metal silver (metal silver/polymer different from gelatin) in the first lead-out wirings 16 and the second lead-out wirings 20 is not particularly limited.

The polymer different from gelatin (hereinafter, also referred to simply as a polymer) is preferably a polymer not containing a protein. In other words, the polymer is preferably a polymer not decomposed by protease.

More specifically, examples of the polymer include at least any resin selected from the group consisting of an acryl-based resin, a styrene-based resin, a vinyl-based resin, a polyolefin-based resin, a polyester-based resin, a polyurethane-based resin, a polyamide-based resin, a polycarbonate-based resin, a polydiene-based resin, an epoxy-based resin, a silicone-based resin, a cellulose-based polymer, a chitosan-based polymer, a copolymer composed of a monomer constituting these resins, and the like. Among these, the polymer is preferably a polymer not decomposed by protease, and examples thereof include an acryl-based resin, a styrene-based resin, a polyester-based resin, and the like.

Furthermore, it is preferable for the polymer to have a reactive group that reacts with a crosslinking agent, which will be described later.

Particularly, examples of preferred embodiments of the polymer include a polymer (copolymer) represented by the following Formula (1) since the polymer can further prevent the permeation of moisture.

-(A)x-(B)y-(C)z-(D)w- Formula (1)

In Formula (1), each of A, B, C, and D represents the following repeating unit.

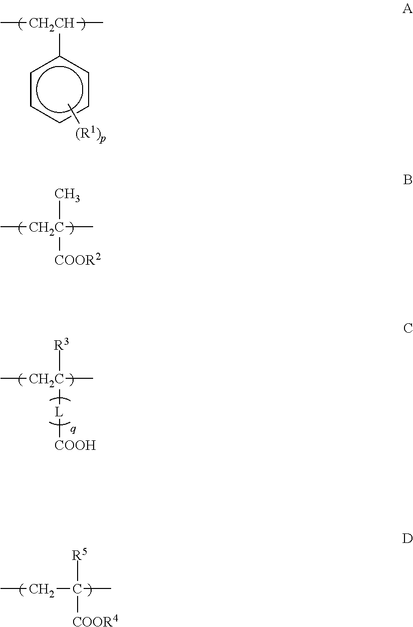

R¹ represents a methyl group or a halogen atom, and preferably represents a methyl group, a chlorine atom, or a bromine atom. p represents an integer of 0 to 2. p is preferably 0 or 1, and more preferably 0.

R² represents a methyl group or an ethyl group, and preferably represents a methyl group.

R³ represents a hydrogen atom or a methyl group, and preferably represents a hydrogen atom. L represents a divalent linking group. L is preferably a group represented by the following Formula (2).

—(CO—X¹)r-X²— Formula (2)

In the formula, X¹ represents an oxygen atom or —NR³⁰—. Herein, R³⁰ represents a hydrogen atom, an alkyl group, an aryl group, or an acyl group, and each of these may have a substituent (for example, a halogen atom, a nitro group, a hydroxyl group, or the like). R³⁰ is preferably a hydrogen atom, an alkyl group having 1 to 10 carbon atoms (for example, a methyl group, an ethyl group, a n-butyl group, a n-octyl group, or the like), or an acyl group (for example, an acetyl group, a benzoyl group, or the like). X¹ is particularly preferably an oxygen atom or —NH—.

X² represents an alkylene group, an arylene group, an alkylene arylene group, an arylene alkylene group, or an alkylene arylene alkylene group. —O—, —S—, —OCO—, —CO—, —COO—, —NH—, —SO₂—, —N(R³¹)—, —N(R³¹)SO₂—, or the like may be inserted into the aforementioned groups. Herein, R³¹ represents a linear or branched alkyl group having 1 to 6 carbon atoms, which includes a methyl group, an ethyl group, an isopropyl group, and the like. Preferable examples of X² include a dimethylene group, a trimethylene group, a tetramethylene group, an o-phenylene group, a m-phenylene group, a p-phenylene group, —CH₂CH₂OCOCH₂CH₂—, —CH₂CH₂OCO(C₆H₄)—, and the like.

r represents 0 or 1.

q represents 0 or 1, and preferably represents 0.

R⁴ represents an alkyl group having 5 to 80 carbon atoms, an alkenyl group, or an alkynyl group. R⁴ is preferably an alkyl group having 5 to 50 carbon atoms, more preferably an alkyl group having 5 to 30 carbon atoms, and even more preferably an alkyl group having 5 to 20 carbon atoms.

R⁵ represents a hydrogen atom, a methyl group, an ethyl group, a halogen atom, or —CH₂COOR⁶. R⁵ is preferably a hydrogen atom, a methyl group, a halogen atom, or —CH₂COOR⁶, more preferably a hydrogen atom, a methyl group, or —CH₂COOR⁶, and particularly preferably a hydrogen atom.

R⁶ represents a hydrogen atom or an alkyl group having 1 to 80 carbon atoms, and may be the same as or different from R⁴. The number of carbon atoms of R⁶ is preferably 1 to 70, and more preferably 1 to 60.

In Formula (1), each of x, y, z, and w represents a molar ratio of each of the repeating units.

x represents 3 mol % to 60 mol %, preferably represents 3 mol % to 50 mol %, and more preferably represents 3 mol % to 40 mol %.

y represents 30 mol % to 96 mol %, preferably represents 35 mol % to 95 mol %, and particularly preferably represents 40 mol % to 90 mol %.

If z is too small, the affinity with hydrophilic protective colloid such as gelatin is reduced, and consequently, a matting agent is highly likely to be aggregated and peeled off. If z is too great, the matting agent of the present invention dissolves in an alkaline treatment solution for a photosensitive material. Therefore, z represents 0.5 mol % to 25 mol %, preferably represents 0.5 mol % to 20 mol %, and particularly preferably represents 1 mol % to 20 mol %.

w represents 0.5 mol % to 40 mol %, and preferably represents 0.5 mol % to 30 mol %.

It is particularly preferable that, in Formula (1), x represents 3 mol % to 40 mol %, y represents 40 mol % to 90 mol %, z represents 0.5 mol % to 20 mol %, and w represents 0.5 mol % to 10 mol %.

As the polymer represented by Formula (1), a polymer represented by the following Formula (4) is preferable.

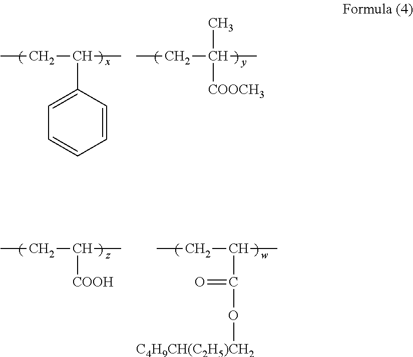

In Formula (4), x, y, z, and w have the same definition as described above.

The polymer represented by Formula (1) may contain other repeating units in addition to Formulae (A), (B), (C), and (D). Examples of monomers for forming other repeating units include acrylic acid esters, methacrylic acid esters, vinyl esters, olefins, crotonic acid esters, itaconic acid diesters, maleic acid diesters, fumaric acid diesters, acrylamides, unsaturated carboxylic acids, an allyl compound, vinyl ethers, vinyl ketones, a vinyl heterocyclic compound, glycidyl esters, unsaturated nitriles, and the like. These monomers are also described in paragraphs [0010] to [0022] of JP 3754745 B.

From the viewpoint of hydrophobicity, acrylic acid esters and methacrylic acid esters are preferable, and hydroxyalkyl methacrylate such as hydroxyethyl methacrylate or hydroxyalkyl acrylate is more preferable. The polymer represented by Formula (1) preferably contains a repeating unit represented by the following Formula (E) in addition to Formulae (A), (B), (C), and (D).

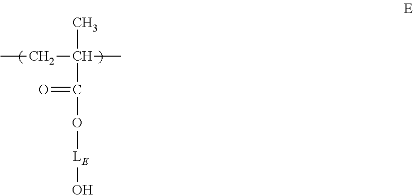

In the formula, L_{E} represents an alkylene group. L_{E} is preferably an alkylene group having 1 to 10 carbon atoms, more preferably an alkylene group having 2 to 6 carbon atoms, and even more preferably an alkylene group having 2 to 4 carbon atoms.

The polymer represented by Formula (1) is particularly preferably a polymer represented by the following Formula (3).

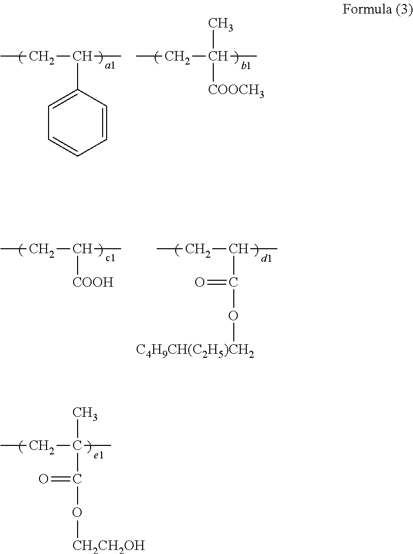

In the formula, each of a1, b1, c1, d1, and e1 represents a molar ratio of each monomer unit. a1 represents 3 (mol %) to 60 (mol %), b1 represents 30 (mol %) to 95 (mol %), c1 represents 0.5 (mol %) to 25 (mol %), d1 represents 0.5 (mol %) to 40 (mol %), and e1 represents 1 (mol %) to 10 (mol %).

The preferable range of a1 is the same as the preferable range of x, the preferable range of b1 is the same as the preferable range of y, the preferable range of c1 is the same as the preferable range of z, and the preferable range of d1 is the same as the preferable range of w.

e1 represents 1 mol % to 10 mol %, preferably represents 2 mol % to 9 mol %, and more preferably represents 2 mol % to 8 mol %.

Specific examples of the polymer represented by Formula (1) will be shown below, but the polymer is not limited to the examples.

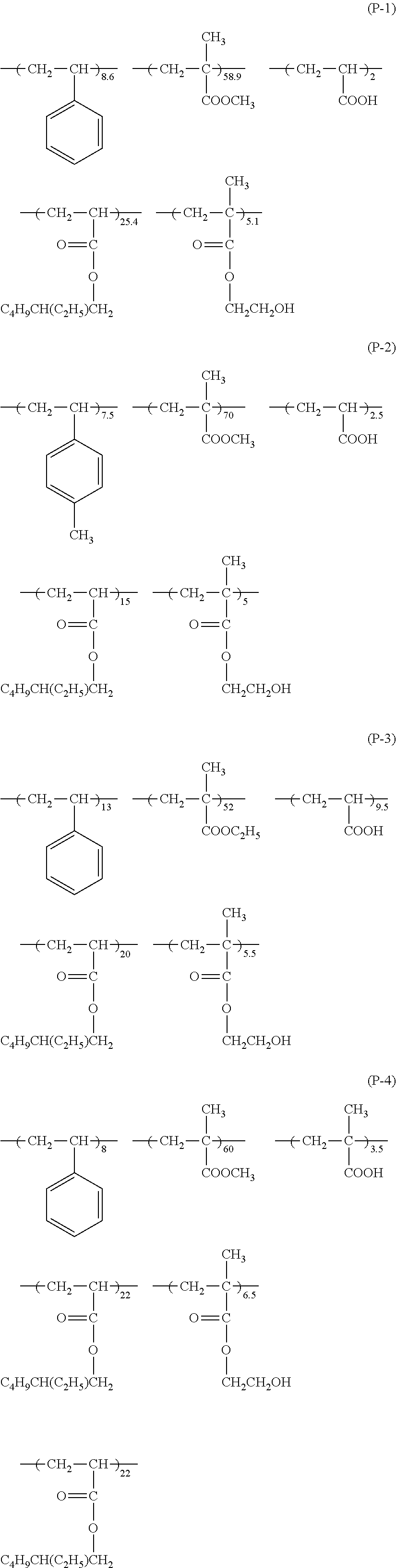

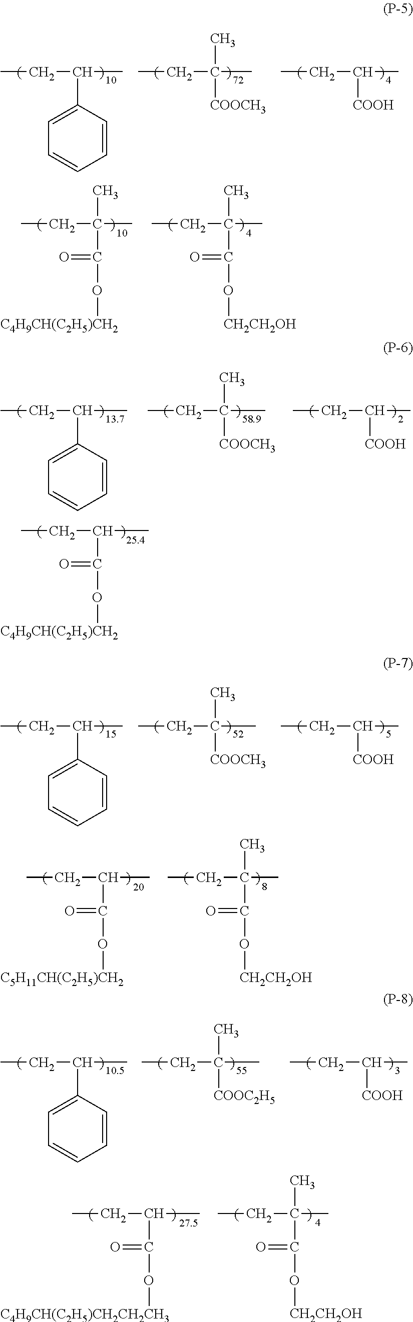

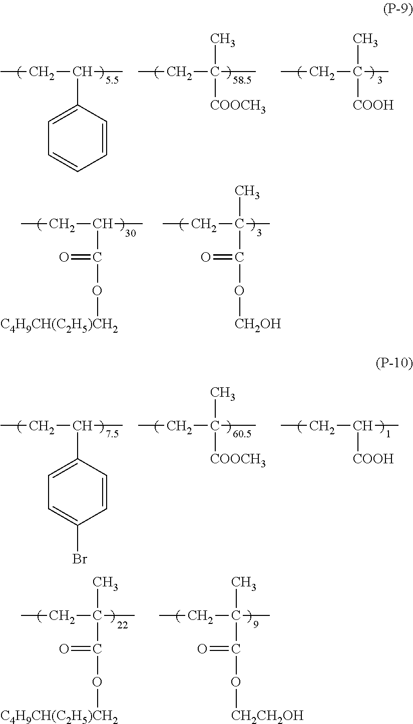

The weight average molecular weight of the polymer represented by Formula (1) is preferably 1,000 to 1,000,000, more preferably 2,000 to 750,000, and even more preferably 3,000 to 500,000.

The polymer represented by Formula (1) can be synthesized with reference to, for example, JP 3305459 B, JP 3754745 B, and the like.

A binder portion may be additionally disposed between the first lead-out wirings 16 (second lead-out wirings 20) on the substrate 12. By providing the binder portion, the ion migration between the first lead-out wirings 16 (second lead-out wirings 20) is further inhibited.

The binder portion contains gelatin or a polymer different from gelatin, and preferably contains gelatin.

The thickness of the binder portion is not particularly limited, but is smaller than the thickness of the thin conductive wire portion in many cases.

The binder portion may contain a component other than the polymer that is different from gelatin.

The protective layer 22 is a layer disposed on the substrate 12 so as to cover the first lead-out wirings 16 and the second lead-out wirings 20. By providing the protective layer 22, the ion migration between the first lead-out wirings 16 and between the second lead-out wirings 20 is inhibited. Although FIG. 3 shows an embodiment in which the protective layer 22 is disposed on the first lead-out wirings 16, the protective layer 22 is also disposed on the second lead-out wirings 20.

The protective layer 22 is formed by using an epoxy resin. The epoxy resin used is not particularly limited, and a known epoxy resin can be used. For example, it is possible to use a glycidyl ether-type epoxy resin, a glycidyl ester-type epoxy resin, a glycidyl amine-type epoxy resin, an oxidized epoxy resin, or the like.

Examples of the glycidyl ether-type epoxy resin include a bisphenol A-type epoxy resin, a bisphenol F-type epoxy resin, a novolac-type epoxy resin, an alcohol-type epoxy resin, and the like. Examples of the glycidyl ester-type epoxy resin include a hydrophthalic acid-type epoxy resin, a dimer acid-type epoxy resin, and the like. Examples of the glycidyl amine-type epoxy resin include an aromatic amine-type epoxy resin, an aminophenol-type epoxy resin, and the like. Examples of the oxidized epoxy resin include an alicyclic epoxy resin and the like. It is also possible to use an epoxy resin having a naphthalene skeleton, a novolac-type epoxy resin having a phenol skeleton and a biphenyl skeleton (biphenyl novolac epoxy resin), a phosphorus-modified epoxy resin, and the like.

The epoxy equivalent of the epoxy resin used is not particularly limited. However, in view of a better ability to inhibit ion migration, the epoxy equivalent is preferably 100 (g/eq) to 1,000,000 (g/eq), and more preferably 100 (g/eq) to 10,000 (g/eq).

The viscosity (25° C.) of the epoxy resin is not particularly limited. However, in view of the better handleability such as solubility of the epoxy resin in a solvent, the viscosity is preferably 1 Pa·s to 1,000 Pa·s, and more preferably 10 Pa·s to 100 Pa·s. Herein, the viscosity is a value measured by using a generally used viscometer (for example, E-type viscometer (RE-80L) manufactured by TOKI SANGYO CO., LTD.) in a state in which the epoxy resin is held at 25° C.

At the time of forming the protective layer, if necessary, a curing agent for the epoxy resin may be used. The type of the curing agent is not particularly limited, and a conventionally known curing agent can be used. Examples of the curing agent include an imidazole-based curing agent, an acid anhydride-based curing agent, and an amine-based curing agent (for example, polyamide amine).

The protective layer may contain a filler. The type of the filler is not particularly limited, and a known filler can be used. Examples of the filler include fillers composed of an aluminum compound, a calcium compound, a potassium compound, a magnesium compound, a silicon compound, a titanium compound, and the like. One kind of these compounds may be used singly, or two or more kinds thereof may be used concurrently.

Examples of the aluminum compound include alumina, aluminum hydroxide, and the like. Examples of the calcium compound include calcium carbonate, calcium hydroxide, and the like. Examples of the potassium compound include potassium carbonate and the like. Examples of the magnesium compound include magnesia, dolomite, basic magnesium carbonate, talc, and the like. Examples of the silicon compound include silica, zeolite, and the like, and examples of the titanium compound include titanium oxide.

The thickness of the protective layer 22 is not particularly limited. However, because the ion migration between lead-out wirings can be further inhibited, the thickness of the protective layer 22 is preferably 5 μm to 200 μm. Considering the external appearance, the thickness of the protective layer 22 is more preferably 10 μm to 100 μm.

The first transparent resin layer 40 and the second transparent resin layer 42 are disposed on the first detection electrodes 14 and the second detection electrodes 18 respectively in the input region E_{I}. The first transparent resin layer 40 is a layer (particularly, an adhesive transparent resin layer) for assuring the adhesion between the first detection electrodes 14 and the first protective substrate 50, and the second transparent resin layer 42 is a layer (particularly, an adhesive transparent resin layer) for assuring the adhesion between the second detection electrodes 18 and the second protective substrate 52.

The thickness of the first transparent resin layer 40 and the second transparent resin layer 42 is not particularly limited, but is preferably 5 μm to 350 μm and more preferably 20 μm to 150 μm. If the thickness is within the above range, an intended visible light transmittance is obtained, and it is also easy to handle the first and second transparent resin layers 40 and 42.

The total light transmittance of the first transparent resin layer 40 and the second transparent resin layer 42 is preferably 85% to 100%.

As the material constituting the first transparent resin layer 40 and the second transparent resin layer 42, a known adhesive is preferably used. Examples of the adhesive include a rubber-based adhesive insulating material, an acryl-based adhesive insulating material, a silicone-based adhesive insulating material, and the like. Among these, in view of excellent transparency, an acryl-based adhesive insulating material is preferable.

The acryl-based adhesive insulating material as a preferred embodiment of the aforementioned adhesive insulating material is a material which contains, as a main component, an acryl-based polymer having a repeating unit derived from alkyl (meth)acrylate. Herein, the (meth)acrylate refers to either or both of acrylate and methacrylate. Among the acryl-based adhesive insulating materials, in view of better adhesiveness, an acryl-based polymer is preferable which has a repeating unit derived from alkyl (meth)acrylate in which an alkyl group has about 1 to 12 carbon atoms, and an acryl-based polymer is more preferable which has a repeating unit derived from the alkyl methacrylate having about 1 to 12 carbon atoms and a repeating unit derived from the alkyl acrylate having about 1 to 12 carbon atoms.

The repeating unit in the aforementioned acryl-based polymer may contain a repeating unit derived from (meth)acrylic acid.

The first protective substrate 50 and the second protective substrate 52 are substrates disposed on the first transparent resin layer 40 and the second transparent resin layer 42 respectively. The first and second protective substrates 50 and 52 are substrates that protect the first detection electrodes 14 or the second detection electrodes 18 from the external environment. Generally, the main surface of one of the protective substrates constitutes a touch screen.

As the first protective substrate 50 and the second protective substrate 52, a plastic film, a plastic plate, a glass plate, or the like which is preferably a transparent substrate is used. It is desirable that the thickness of the protective substrates be appropriately selected according to the purpose thereof.

As the raw material of the aforementioned plastic film and plastic plate, for example, it is possible to use polyesters such as polyethylene terephthalate (PET) and polyethylene naphthalate (PEN); polyolefins such as polyethylene (PE), polypropylene (PP), polystyrene, and EVA; a vinyl-based resin; and others such as polycarbonate (PC), polyamide, polyimide, an acrylic resin, triacetyl cellulose (TAC), a cycloolefin-based resin (COP), and the like.

Furthermore, as the first protective substrate 50 and the second protective substrate 52, a liquid crystal display, a polarizing plate, a circularly polarizing plate, and the like may be used.

In the external conduction region G of FIG. 1, a flexible printed wiring board, not shown in the drawing, is disposed. The flexible printed wiring board is a board in which a plurality of wirings and terminals are provided on a substrate. The flexible printed wiring board is connected to the other end of each of the first lead-out wirings 16 and the other end of each of the second lead-out wirings 20, and plays a role of connecting the touch panel 10 to an external apparatus (for example, a liquid crystal display apparatus).

Next, the operation that the touch panel 10 performs to detect an input position will be described.

When a finger as a conductor approaches, touches, or presses an operation surface (the surface of the first protective substrate 50) of the substrate 12 corresponding to the input region E_{I}, the capacitance between the finger and the first detection electrodes 14 as well as the second detection electrodes 18 changes. A position detection driver, not shown in the drawing, detects the change in capacitance between the finger and the first detection electrodes 14 as well as the second detection electrodes 18 at all times, and when a change in capacitance that is equal to or greater than a predetermined value is detected by the position detection driver, the position in which the change in capacitance is detected is detected as an input position. In this way, the touch panel 10 can detect the input position. As the method that the touch panel 10 uses to detect the input position, any of a mutual capacitance method and a self capacitance method may be adopted. If the mutual capacitance method is adopted, a plurality of input positions can be detected simultaneously. Therefore, it is better to adopt such a method than to adopt the self capacitance method.

In the above section, the touch panel 10 that performs the input operation via the first protective substrate 50 corresponding to the input region E_{I} was described as an example. However, the present invention is not limited thereto. That is, the present invention may be a touch panel that performs the input operation via the second protective substrate 52 corresponding to the input region Ei.

(Manufacturing Method of Touch Panel)

The manufacturing method of the touch panel 10 is not particularly limited, and a known method can be adopted.

First, as a method for forming the first detection electrodes 14 and the first lead-out wirings 16; and the second detection electrodes 18 and the second lead-out wirings 20 on the substrate 12, for example, a method of using silver halide can be adopted. More specifically, a method can be adopted which includes a step (1) of forming a silver halide emulsion layer (hereinafter, also referred to simply as a photosensitive layer) containing silver halide and gelatin on both surfaces of the substrate 12, and a step (2) of forming the first detection electrodes 14 and the first lead-out wirings 16; and the second detection electrodes 18 and the second lead-out wirings 20 by performing exposure and then a development treatment on the photosensitive layers.

Hereinafter, each of the steps will be described.

[Step (1): Photosensitive Layer Forming Step]

The step (1) is a step of forming a photosensitive layer containing silver halide and gelatin on both surfaces of the substrate 12.

The method for forming the photosensitive layer is not particularly limited. However, in view of productivity, it is preferable to use a method of forming the photosensitive layer on both surfaces of the substrate 12 by means of bringing a composition for forming a photosensitive layer, which contains silver halide and gelatin, into contact with the substrate 12.

Hereinafter, embodiments of the composition for forming a photosensitive layer that is used in the aforementioned method will be specifically described, and then the procedure of the step will be specifically described.

The composition for forming a photosensitive layer contains silver halide and gelatin.

The halogen element contained in the silver halide may be any of chlorine, bromine, iodine, and fluorine, and these may be used in combination. As the silver halide, for example, silver halide which contains silver chloride, silver bromide, or silver iodide as a main component is preferably used, and silver halide which contains silver bromide or silver chloride as a main component is more preferably used.

The type of the gelatin used is as described above.

The volume ratio of the silver halide to the gelatin contained in the composition for forming a photosensitive layer is not particularly limited, and is appropriately adjusted so as to fall within the aforementioned preferable range of the volume ratio of the metal to the binder in the thin conductive wires 30.

If necessary, the composition for forming a photosensitive layer contains a solvent.

Examples of the solvent used include water, organic solvents (for example, alcohols such as methanol, ketones such as acetone, amides such as formamide, sulfoxides such as dimethyl sulfoxide, esters such as ethyl acetate, and ethers), ionic liquids, and mixed solvents composed of these.

The content of the solvent used is not particularly limited. However, it is preferably within a range of 30% by mass to 90% by mass, and more preferably within a range of 50% by mass to 80% by mass, with respect to the total mass of the silver halide and the gelatin.

If necessary, the composition for forming a photosensitive layer may contain materials other than the aforementioned materials. Examples of such materials include a metal compound belonging to group VIII and group VIIIB such as a rhodium compound and an iridium compound used for stabilizing and highly sensitizing silver halide, and also include an antistatic agent, a nucleating agent, a spectral sensitizing dye, a surfactant, an anti-fogging agent, a film hardening agent, a black spot inhibitor, a redox compound, a monomethine compound, dihydroxybenzenes, and the like described in paragraphs [0220] to [0241] of JP 2009-004348 A. Furthermore, the composition for forming a photosensitive layer may also contain a physical development nucleus.

Particularly, the composition for forming a photosensitive layer preferably contains a crosslinking agent used for cross-linking the aforementioned polymers to each other. If the composition for forming a photosensitive layer contains the crosslinking agent, cross-linking proceeds between the polymers, and the metal silver particles in the conductive portion remain linked to each other. Consequentially, a conductive film having excellent conductivity is obtained.

The type of the crosslinking agent used is not particularly limited, and depending on the structure of the polymer used, an optimal crosslinking agent is appropriately selected. Generally, the crosslinking agent has at least two crosslinking groups that react with the group (reactive group) contained in the polymer.

In view of better reactivity, examples of suitable combinations of the reactive group in the polymer and the crosslinking group in the crosslinking agent include the following (1) to (8).

(1) A hydroxyl group with an isocyanate group

(2) A carboxylic acid group with an epoxy group

(3) A hydroxyl group with a carboxylic anhydride group

(4) A carboxylic acid group with an isocyanate group

(5) An amino group with an isocyanate group

(6) A hydroxyl group with an epoxy group

(7) An amino group with an epoxy group

(8) An amino group with an alkyl halide group

Examples of the crosslinking agent include vinyl sulfones (for example, 1,3-bisvinylsulfonyl propane), aldehydes (for example, glyoxal), pyrimidine chlorides (for example, 2,4,6-trichloropyrimidine), triazine chlorides (for example, cyanuric chloride), an epoxy compound, a carbodimide compound, and the like. Furthermore, a crosslinking agent may be used which causes a crosslinking reaction by using a photochemical reaction induced by light irradiation.

(Procedure of Step)

The method for bringing the composition for forming a photosensitive layer into contact with the substrate 12 is not particularly limited, and a known method can be adopted. For example, it is possible to adopt a method of coating the substrate 12 with the composition for forming a photosensitive layer, a method of dipping the substrate 12 into the composition for forming a photosensitive layer, and the like.

The content of the silver halide in the photosensitive layer is not particularly limited. However, in view of further improving the conductivity, the content of the silver halide is preferably 1.0 g/m² to 20.0 g/m², and more preferably 5.0 g/m² to 15.0 g/m² expressed in terms of silver.

If necessary, a protective layer composed of a binder may be additionally provided on the photosensitive layer. If the protective layer is provided, scratches are prevented, or dynamic characteristics are improved.

[Step (2): Exposure and Development Step]

The step (2) is a step of pattern-wise exposing the photosensitive layers obtained in the step (1) to light and performing development treatment on the photosensitive layers such that the first detection electrodes 14 and the first lead-out wirings 16; and the second detection electrodes 18 and the second lead-out wirings 20 are formed.

Hereinafter, first, the pattern exposure treatment will be specifically described, and then the development treatment will be specifically described.

(Pattern Exposure)

When the photosensitive layers are pattern-wise exposed to light, in the exposed region, the silver halide in the photosensitive layer forms a latent image. In the region in which the latent image is formed, the first detection electrodes 14 and the first lead-out wirings 16; and the second detection electrodes 18 and and the second lead-out wirings 20 are formed by the development treatment, which will be described later. In contrast, in the unexposed region that is not exposed to light, the silver halide dissolves and flows out of the photosensitive layers at the time of fixing treatment, which will be described later, and thus a transparent film is obtained.

The light source used for exposure is not particularly limited, and examples thereof include light such as visible rays and ultraviolet rays, radiation such as X-rays, and the like.

The method for performing the pattern exposure is not particularly limited. For example, the pattern exposure may be performed by double-sided exposure using a photomask or scanning exposure using laser beams. Herein, the form of the pattern is not particularly limited and appropriately adjusted according to the intended pattern of the thin conductive wires to be formed.

(Development Treatment)

The method of the development treatment is not particularly limited, and for example, it can be selected from among the following three methods depending on the type of the photosensitive layer.

(1) A method of forming metal silver by performing chemical development or thermal development on a photosensitive layer not containing a physical development nucleus

(2) A method of forming metal silver by performing dissolution physical development on a photosensitive layer containing a physical development nucleus

(3) A method of forming metal silver by superimposing an image receiving sheet, which has a non-photosensitive layer containing a physical development nucleus, on a photosensitive layer not containing a physical development nucleus, and performing diffusion transfer development

The chemical development, thermal development, dissolution physical development, and diffusion transfer development mentioned herein have the same meaning that are generally used in the field of related art, and are explained in general photographic chemistry textbooks, for example, “Photographic Chemistry” (Shinichi Kikuchi, KYORITSU SHUPPAN CO., LTD.) and “The Theory of Photographic Process, 4th ed.” (C. E. K. Mees, Mcmillan, 1977). Furthermore, for example, the techniques described in JP 2004-184693 A, JP 2004-334077 A, JP 2005-010752 A, and the like can also be referred to.

Among the methods (1) to (3), in the method (1), the photosensitive layer having not yet been subjected to development does not have a physical development nucleus. Furthermore, the method (1) is not a diffusion transfer method using 2 sheets. Accordingly, the method (1) makes it possible to most simply and stably perform the treatment, and is preferable for manufacturing the conductive sheet of the present invention. Hereinafter, a case of using the method (1) will be described. However, in a case of using other methods, the documents described above can be referred to. Herein, the “dissolution physical development” is not a development method inherent in the method (2), and can be used in the method (1).

The method of development treatment is not particularly limited, and known methods can be adopted. For example, it is possible to use general technologies of the development treatment used for silver halide photographic films, photographic printing paper, films for making printing plates, emulsion masks for photomasks, and the like.

The type of the developer used at the time of development treatment is not particularly limited, and for example, it is possible to use a PQ developer, an MQ developer, an MAA developer, and the like. As commercially available products, for example, it is possible to use developers such as CN-16, CR-56, CP45X, FD-3, and Papitol formulated by FUJIFILM Corporation, C-41, E-6, RA-4, D-19, and D-72 formulated by KODAK, and developers included in the kit thereof. Furthermore, it is possible to use a lithographic developer.

The development treatment can include fixing treatment performed for stabilization by removing silver halide in an unexposed portion. For the fixing treatment, it is possible to use technologies of the fixing treatment used for silver halide photographic films, photographic printing paper, films for making printing plates, emulsion masks for photomasks, and the like.

In the fixing treatment, the fixing temperature is preferably about 20° C. to about 50° C., and more preferably 25° C. to 45° C. The fixing time is preferably 5 seconds to 1 minute, and more preferably 7 seconds to 50 seconds.

The mass of metal silver contained in the exposed portion having undergone the development treatment (thin conductive wires) is preferably equal to or greater than 50% by mass, and more preferably equal to or greater than 80% by mass, with respect to the mass of silver contained in the exposed portion having not yet been exposed to light. If the mass of silver contained in the exposed portion is equal to or greater than 50% by mass with respect to the mass of silver contained in the exposed portion having not yet been exposed to light, it is preferable because a high degree of conductivity can be obtained.

The method for forming the protective layer 22 on the first lead-out wirings 16 and the second lead-out wirings 20 formed as above is not particularly limited. For example, by coating the first lead-out wirings 16 and the second lead-out wirings 20 with a resin composition for forming a protective layer containing the aforementioned epoxy resin and then performing curing treatment on the resin composition, the protective layer 22 can be manufactured.

The definition of the epoxy resin contained in the resin composition for forming a protective layer is as described above.

If necessary, the resin composition for forming a protective layer may contain a component (for example, a curing agent, a filler, a solvent, an acid generator, or the like) other than the epoxy resin.

The coating method of the resin composition for forming a protective layer is not particularly limited, and examples thereof include an ink jet method, a screen printing method, a dispenser method, and the like.

The method of the curing treatment is not particularly limited, and examples thereof include heating treatment and light irradiation treatment. Because heating treatment is better in level of curing, heating treatment is preferable.

The conditions of the heating treatment are not particularly limited, and optimal conditions are appropriately selected according to the type of the epoxy resin used. Generally, in view of heat resistance or the like of the substrate, it is preferable to perform the heating treatment at 40° C. to 150° C. (preferably at 50° C. to 120° C.) for no longer than 2 hours (preferably for 0.2 hours to 1 hour).

The method for forming the first transparent resin layer 40 and the second transparent resin layer 42 is not particularly limited, and examples thereof include a method of bonding a known transparent resin film, a method of forming a layer by coating with a composition for forming a transparent resin layer that forms a transparent resin layer, and the like.

The method for forming the first protective substrate 50 and the second protective substrate 52 is not particularly limited, and examples thereof include a method of bonding a protective substrate onto each of the first transparent resin layer 40 and the second transparent resin layer 42.

In the above section, an embodiment in which the first detection electrode and the second detection electrode are disposed on the front and rear surfaces of the substrate was specifically described. However, the touch panel of the present invention is not limited to the embodiment.

Hereinafter, other embodiments of the touch panel of the present invention will be specifically described.

### Second Embodiment

FIG. 5 is a cross-sectional view of a portion of a second embodiment of the touch panel of the present invention. Herein, FIG. 5 is a schematic view for facilitating understanding of the layer constitution of a touch panel 200, and a portion of the touch panel 200 is not shown in the drawing.

As shown in FIG. 5, the touch panel 200 includes a second substrate 62, the second detection electrodes 18 disposed on the second substrate 62, second lead-out wirings (not shown in the drawing) which are electrically connected to one end of the second detection electrodes 18 and are disposed on the second substrate 62, the second transparent resin layer 42, the first detection electrodes 14, the first lead-out wirings 16 (not shown in the drawing) electrically connected to one end of the first detection electrodes 14, a first substrate 60 to which the first detection electrodes 14 and the first lead-out wirings 16 are adjacent, the first transparent resin layer 40, the first protective substrate 50, and a protective layer (not shown in the drawing) covering the first lead-out wirings and the second lead-out wirings.

The layers included in the touch panel 200 shown in FIG. 5 are the same as those included in the touch panel 10 shown in FIG. 1, except that the order of the respective layers is different. Therefore, the same constituents are marked with the same reference numerals so as not to repeat the description thereof. Herein, each of the first substrate 60 and the second substrate 62 is the same layer as the substrate 12 shown in FIG. 1, and the definition thereof is as described above.

In FIG. 5, a plurality of first detection electrodes 14 and a plurality of second detection electrodes 18 are used as shown in FIG. 1 and are disposed such that the first detection electrodes 14 are orthogonal to the second detection electrodes 18 as shown in FIG. 1.

The touch panel 200 shown in FIG. 5 corresponds to a touch panel obtained by preparing two sheets of substrates with electrodes each of which is composed of a substrate and detection electrodes and lead-out wirings disposed on the surface of the substrate, and bonding the substrates with electrodes to each other via a transparent resin layer such that the electrodes face each other.

### Third Embodiment

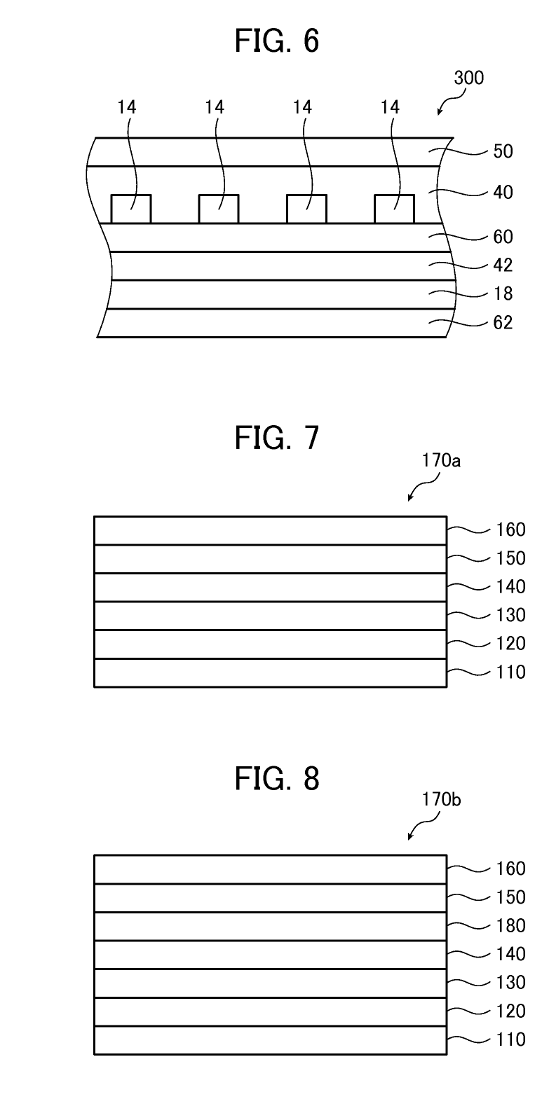

FIG. 6 is a cross-sectional view showing a portion of a third embodiment of the touch panel of the present invention. Herein, FIG. 6 is a schematic view for facilitating understanding of the layer constitution of a touch panel 300, and a portion of the touch panel 300 is not shown in the drawing.

As shown in FIG. 6, the touch panel 300 includes the second substrate 62, the second detection electrodes 18 disposed on the second substrate 62, second lead-out wirings (not shown in the drawing) which are electrically connected to one end of the second detection electrodes 18 and disposed on the second substrate 62, the second transparent resin layer 42, the first substrate 60, the first detection electrodes 14 disposed on the first substrate 60, first lead-out wirings (not shown in the drawing) which are electrically connected to one end of the first detection electrodes 14 and are disposed on the first substrate 60, the first transparent resin layer 40, the first protective substrate 50, and a protective layer (not shown in the drawing) covering the first lead-out wirings and the second lead-out wirings.

The layers included in the touch panel 300 shown in FIG. 6 are the same as the layers included in the touch panel 10 shown in FIG. 1, except that the order of the respective layers is different. Therefore, the same constituents are marked with the same reference numerals so as not to repeat the description thereof.

In FIG. 6, a plurality of first detection electrodes 14 and a plurality of second detection electrodes 18 are used as shown in FIG. 1 and are disposed such that the first detection electrodes 14 are orthogonal to the second detection electrodes 18 as shown in FIG. 1.

The touch panel 300 shown in FIG. 6 corresponds to a touch panel obtained by preparing two sheets of substrates with electrodes each of which is composed of a substrate and detection electrodes and lead-out wirings disposed on the surface of the substrate, and bonding the substrates with electrodes to each other via a transparent resin layer such that one of the substrates with electrodes face the electrodes of the other substrate with electrodes.

The constitution of an input device including the touch panel of the present invention is not particularly limited, and as the input device, the embodiment shown in FIG. 7 is exemplified. The embodiment shown in FIG. 7 corresponds to an embodiment of a so-called out-cell type, and an input device 170a shown in FIG. 7 includes a backlight 110, a first polarizing plate 120, a liquid crystal display (LCD) 130, a second polarizing plate 140, a touch panel 150 of the present invention, and a protective substrate 160 in this order. Between the second polarizing plate 140 and the touch panel 150, a spacer, not shown in the drawing, is disposed.

The embodiment of the input device is not limited to the embodiment shown in FIG. 7, and also includes, for example, an input device 170b shown in FIG. 8 that includes the backlight 110, the first polarizing plate 120, the liquid crystal display (LCD) 130, the second polarizing plate 140, an adhesive layer 180, the touch panel 150 of the present invention, and the protective substrate 160 in this order.

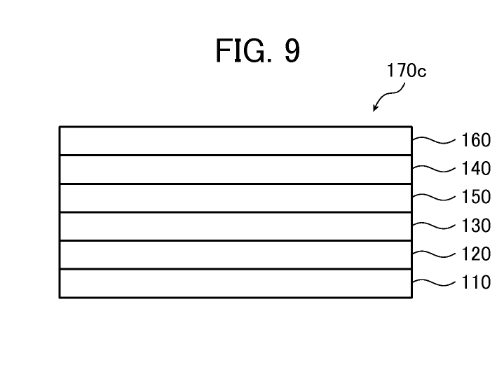

Furthermore, as another embodiment of the input device, for example, there is an input device 170c shown in FIG. 9 that includes the backlight 110, the first polarizing plate 120, the liquid crystal display (LCD) 130, the touch panel 150 of the present invention, the second polarizing plate 140, and the protective substrate 160 in this order.

The touch panel (capacitance-type touch panel) of the present invention is not limited to the aforementioned embodiments. It goes without saying that various constitutions can be adopted within a range that does not depart from the gist of the present invention. Furthermore, the touch panel of the present invention can be used by being appropriately combined with the techniques disclosed in JP 2011-113149 A, JP 2011-129501 A, JP 2011-129112 A, JP 2011-134311 A, JP 2011-175628 A, and the like.

### EXAMPLES

Hereinafter, the present invention will be more specifically described based on examples, but the present invention is not limited thereto.

### Example A

### Example 1

### Preparation of Silver Halide Emulsion

To the following Liquid 1 kept at 38° C. and pH 4.5, 90% of the following Liquid 2 and Liquid 3 were simultaneously added over 20 minutes while being stirred, thereby forming 0.16 μm of nuclear particles. Subsequently, the following Liquid 4 and Liquid 5 were added thereto over 8 minutes, and then the remaining 10% of the following Liquid 2 and Liquid 3 were added thereto over 2 minutes, such that the particles grew into 0.21 μm of particles. Thereafter, 0.15 g of potassium iodide was added thereto, the particles were allowed to mature for 5 minutes, and then the formation of particles was ended.

| Liquid 1: | | |
|---|---|---|
| Water | 750 | ml |
| Gelatin | 9 | g |
| Sodium chloride | 3 | g |
| 1,3-Dimethylimidazolidine-2-thione | 20 | mg |
| Sodium benzene thiosulfonate | 10 | mg |
| Citric acid | 0.7 | g |
| Liquid 2: | | |
| Water | 300 | ml |
| Silver nitrate | 150 | g |
| Liquid 3: | | |
| Water | 300 | ml |
| Sodium chloride | 38 | g |
| Potassium bromide | 32 | g |
| Potassium hexachloroiridate (III) | 8 | ml |
| (0.005% KCl 20% aqueous solution) | | |
| Ammonium hexachlororhodate | 10 | ml |
| (0.001% NaCl 20% aqueous solution) | | |
| Liquid 4: | | |
| Water | 100 | ml |
| Silver nitrate | 50 | g |
| Liquid 5: | | |
| Water | 100 | ml |
| Sodium chloride | 13 | g |
| Potassium bromide | 11 | g |
| Potassium ferrocyanide | 5 | mg |

Thereafter, according to a common method, the resultant was washed with water by a flocculation method. Specifically, the resultant was cooled to 35° C., and the pH thereof was reduced by using sulfuric acid until the silver halide was precipitated (the pH was within a range of 3.6±0.2). Next, about 3 L of supernatant liquid was removed (first washing with water). Subsequently, 3 L of distilled water was added thereto, and then sulfuric acid was added thereto until the silver halide was precipitated. Then 3 L of supernatant liquid was removed again (second washing with water). The same operation as the second washing with water was repeated once (third washing with water), and then the step of washing with water and demineralization was ended. The pH of the emulsion obtained after the washing with water and demineralization was adjusted to 6.4, and the pAg thereof was adjusted to 7.5. Next, by adding 3.9 g of gelatin, 10 mg of sodium benzene thiosulfonate, 3 mg of sodium benzene thiosulfinate, 15 mg of sodium thiosulfate, and 10 mg of chloroauric acid to the emulsion, chemical sensitization was performed on the emulsion such that the emulsion exhibited optimal sensitivity at 55° C. Thereafter, 100 mg of 1,3,3a,7-tetraazaindene as a stabilizer and 100 mg of Proxel (trade name, manufactured by ICI Co., Ltd.) as a preservative were added thereto. The finally obtained emulsion was an emulsion of cubic silver iodochlorobromide particles that contained 0.08 mol % of silver iodide and silver chlorobromide composed of silver chloride and silver bromide at a ratio of 70 mol % and 30 mol %, and had an average particle size of 0.22 μm and a coefficient of variation of 9%.

(Preparation of Composition for Forming Photosensitive Layer)

To the aforementioned emulsion, 1,3,3a,7-tetraazaindene in an amount of 1.2×10 mol/mol Ag, hydroquinone in an amount of 1.2×10⁻² mol/mol Ag, citric acid in an amount of 3.0×10⁻⁴ mol/mol Ag, and 2,4-dichloro-6-hydroxy-1,3,5-triazine sodium salt in an amount of 0.90 g/mol Ag were added. By using citric acid, the pH of the coating liquid was adjusted to be 5.6, thereby obtaining a composition for forming a photosensitive layer.

(Photosensitive Layer Forming Step)

A polyethylene terephthalate (PET) film having a thickness of 100 μm was subjected to corona discharge treatment. Thereafter, on both surfaces of the PET film, a gelatin layer having a thickness of 0.1 μm was provided as an undercoat layer, and on the undercoat layer, an anti-halation layer, which had an optical density of about 1.0 and contained a dye that was bleached by alkali of a developer, was provided. The anti-halation layer was coated with the composition for forming a photosensitive layer, and a gelatin layer having a thickness of 0.15 μm was provided thereon, thereby obtaining a PET film in which a photosensitive layer was formed on both surfaces thereof. The obtained film was named Film A. The formed photosensitive layer contained silver in an amount of 6.0 g/m² and gelatin in an amount of 1.0 g/m².

(Exposure and Development Step)

Through a photomask, in which the pattern of the touch panel sensor (the first detection electrodes and the second detection electrodes) and the lead-out wiring portion (the first lead-out wirings and the second lead-out wirings) were arranged as shown in FIG. 1, both surfaces of the aforementioned film A were exposed to parallel light from a high-pressure mercury lamp used as a light source. After being exposed to light, the film A was developed with the following developer and further subjected to development treatment by using a fixing solution (trade name: N3X-R for CN16X, manufactured by FUJIFILM Corporation). The film A was then rinsed with pure water and dried, thereby obtaining the PET film in which an electrode pattern composed of Ag thin wires and a gelatin layer were formed on both surfaces thereof. The gelatin layer was formed between Ag thin wires. The obtained film was named Film B. The L/S (line/space) of the lead-out wiring portion was 100 μm/100 μm.

(Composition of Developer)

1 L of the developer contained the following compounds.

| | |
|---|---|
| Hydroquinone | 0.037 mol/L |
| N-methylaminophenol | 0.016 mol/L |
| Sodium metaborate | 0.140 mol/L |
| Sodium hydroxide | 0.360 mol/L |
| Sodium bromide | 0.031 mol/L |
| Potassium metabisulfite | 0.187 mol/L |

The lead-out wiring portion (the first lead-out wirings and the second lead-out wirings) of the film B obtained as above was coated with an epoxy resin composition (LPD-200, manufactured by Henkel Japan Ltd.) by using a dispenser, and the epoxy resin composition was then subjected to heating treatment at 80° C. for 0.5 hours, thereby manufacturing a protective layer (thickness: 100 μm).

The epoxy resin composition contained an inorganic filler.

On one surface (bottom surface) of the film B obtained as above, OCA (#8146-4: a thickness of 100 μm) manufactured by 3M Company and a hard coat film (G1SBF: a thickness of 50 μm) manufactured by KIMOTO CO., LTD. were laminated in this order. Furthermore, onto the other surface (top surface) of the film B, OCA (#8146-4: a thickness of 100 μm) manufactured by 3M Company was bonded, thereby preparing a laminate. Herein, the portions of OCA and the hard coat film that were positioned on the other ends of the first lead-out wirings and the second lead-out wirings and corresponded to a portion to which an FPC will be pressure-bonded, were cut out beforehand such that an FPC could be pressure-bonded thereto.

The external form of the laminate was trimmed such that it had the same size as that of soda lime glass having a thickness of 0.7 mm approximate to a sensor size; an FPC was pressure-bonded thereto by using ACF (CP906AM-25AC) manufactured by Sony Chemicals Corporation; and the aforementioned soda lime glass was bonded onto the top side thereof, thereby preparing a touch panel.

(Evaluation of HHBT Resistance)

The FPC wiring portion of the sample obtained as above was connected to a function generator, and the time taken for a short circuit to occur was measured under conditions of 85° C./85%/DC 5V.

### Example 2

A touch panel was manufactured according to the same procedure as in Example 1, except that, as the epoxy resin composition, an epoxy resin composition (927-10E, manufactured by Henkel Japan Ltd.) was used instead of the epoxy resin composition (LPD-200, manufactured by Henkel Japan Ltd.). The HHBT resistance of the touch panel was evaluated. The result is shown in Table 1.

Herein, the aforementioned epoxy resin composition contained an inorganic filler.

### Comparative Example 1

A touch panel was manufactured according to the same procedure as in Example 1, except that an acrylic resin composition (SVR1320, manufactured by Dexerials Corporation) was used instead of the epoxy resin composition (LPD-200, manufactured by Henkel Japan Ltd.). The HHBT resistance of the touch panel was evaluated, and the result is shown in Table 1.

### Comparative Example 2

A touch panel was manufactured according to the same procedure as in Example 1, except that a polyester resin composition (CR-18T-KT1, manufactured by Asahi Chemical Research Laboratory Co., Ltd.) was used instead of the epoxy resin composition (LPD-200, manufactured by Henkel Japan Ltd.). The HHBT resistance of the touch panel was evaluated. The result is shown in Table 1.

### Comparative Example 3

A touch panel was manufactured according to the same procedure as in Example 1, except that a silicone resin composition (RTV SE9186, manufactured by Dow Corning Toray Co., Ltd.) was used instead of the epoxy resin composition (LPD-200, manufactured by Henkel Japan Ltd.). The HHBT resistance of the touch panel was evaluated. The result is shown in Table 1.

TABLE 1

| | | | | Compar- | Compar- |
|---|---|---|---|---|---|
| | | | Comparative | ative | ative |
| | Example 1 | Example 2 | example 1 | example 2 | example 3 |
| Type of | Epoxy | Epoxy | Acrylic | Polyester | Silicone |
| resin | resin | resin | resin | resin | resin |
| HHBT | 15.5 | 15 | 0.1 | 0.1 | 0.5 |
| resistance | | | | | |
| (h) | | | | | |

As is evident from Table 1, it was confirmed that, in Examples 1 and 2 in which the protective layer formed by using an epoxy resin was used, the HHBT resistance was excellent.

What is claimed is:

1. A touch panel having an input region and an outside region positioned outside the input region, comprising at least:
a substrate;
detection electrodes disposed on the substrate corresponding to the input region;
lead-out wirings which are disposed on the substrate corresponding to the outside region and are electrically connected to the detection electrodes; and
a protective layer disposed on the substrate corresponding to the outside region so as to cover the lead-out wirings,
wherein the protective layer is formed by using an epoxy resin, and
the lead-out wirings contain metal silver and gelatin.

2. The touch panel according to claim 1,
wherein the protective layer contains a filler.
